(19) United States
(12) Patent Application Publication
(10) Pub. No.: US 2013/0306473 A1
(43) Pub. Date: Nov. 21, 2013

(54) METHOD FOR PRODUCING A DEVICE FOR DETECTING AN ANALYTE AND DEVICE AND THE USE THEREOF

(71) Applicants: Enno Kaetelhoen, Aachen (DE); Marco Banzet, Goilenkirchen (DE); Boris Hofmann, Tuebingen (DE); Dirk Mayer, Frechen (DE); Bernhard Wolfrum, Aachen (DE)

(72) Inventors: Enno Kaetelhoen, Aachen (DE); Marco Banzet, Goilenkirchen (DE); Boris Hofmann, Tuebingen (DE); Dirk Mayer, Frechen (DE); Bernhard Wolfrum, Aachen (DE)

(73) Assignee: FORSCHUNGSZENTRUM JUELICH GMBH, Juelich (DE)

(21) Appl. No.: 13/981,454

(22) PCT Filed: Jan. 17, 2012
(86) PCT No.: PCT/DE12/00043

§ 371 Date: Jul. 31, 2013

(30) Foreign Application Priority Data
Feb. 9, 2011 (DE) 10 2011 010 767.3

(51) Int. Cl. G01N 27/327

(52) U.S. Cl. CPC G01N 27/3277
USPC 204/403.01; 427/58

(57) ABSTRACT

A method for producing a device for detecting an analyze, comprises the following steps: a) disposing a first conductor having an electrode function on an insulating substrate; b) disposing a first passivation layer on the conductor; c) opening the passivation layer in a locally delimited manner, so that the conductor is exposed in a locally delimited manner; d) disposing a sacrificial layer on the conductor in the opening; g) disposing a second passivation layer on the electrode and on the second conductor; h) opening the second passivation layer and the electrode so that the sacrificial layer is exposed; and i) removing the sacrificial layer. Also comprising an appropriately designed device and the use thereof.

The invention relates to a method for producing a device for detecting an analyte, to a device per se and to the use thereof.

Numerous substances can be detected electrochemically. To this end, a solution including one or more of the substances to be measured is brought to a defined potential by way of a reference electrode. In the simplest case, a further electrode is added, on which the detection can take place. If this electrode has a potential that is suitable for oxidation or reduction of the analyte, a reaction takes place on the electrode. The analytes are oxidized or reduced at the electrode surface, whereby a current flow is generated, which can be measured on the electrode. This current flow is proportional to the number of converted molecules and allows precise conclusions regarding the concentration of the molecules in the sample.

A known example of this is the glucose oxidate assay, which is used clinically to determine blood sugar levels, In this assay, glucose is catalyzed in a bioreactor using the enzyme glucose oxidate to obtain gluconolactone and hydrogen peroxide. The hydrogen peroxide concentration can be measured electrochemically. Because this concentration is proportional to that of glucose, it is possible to exactly determine the glucose component.

While the method is being successfully employed in numerous tests, it nonetheless entails several method-related drawbacks, which preclude use in broader fields of application. For example, the electrode current, and consequently the sensitivity of the sensor, is always limited by the mass transport of the analyte to the electrode. During the measurement, molecules of the analyte, which have already reacted on the electrode surface, are replaced with native molecules of the sample by way of diffusion. Because this process generally takes place considerably more slowly than the electrode reaction, this limits the current flow on the electrode, and thus also limits the sensitivity of the sensor. Additionally, the sensors can only be miniaturized to a certain degree. The smaller the electrode surface, the lower the number of molecules that can react thereon. This method can thus be used in lab-on-a-chip applications only conditionally. Moreover, the packing density of these sensors on a chip is limited because contact must be made by a separate conductor with every sensor.

Some of these problems can be solved by the method of reciprocal reduction and oxidation of the analyte, which hereafter is also referred to in abbreviated form as the redox cycling method. In this approach, a second electrode is added to the measurement set-up described above, this electrode being located in the direct vicinity of the first electrode. During measurement, oxidizing potential is applied to one electrode and reducing potential to the other. Individual molecules thus react repeatedly on the electrodes and generate a steady current flow between the electrodes, which behaves in a manner proportional to the concentration of the analyte. This current flow is no longer limited by the mass transport of the native analyte to the electrode, but only by the diffusion rate of the analyte between the electrodes. An increase in sensitivity of several orders of magnitude can thus be achieved with small electrode spacing, in the nanometer range. The method and the sensor were described in Wolfrum et al. (B. Wolfrum, M. Zevenbergen, and S. Lemay, “Nanofluidic Redox Cycling Amplification for the Selective Detection of Catechol”, Analytical Chemistry, Volume 80, No. 4, pages 972-977, February 2008). Redox cycling sensors additionally demonstrate higher selectivity because not all electrochemically detectable molecules can participate in repeated redox reactions. However, numerous neuotransmitters such as dopamine, adrenaline or serotonin are suitable for this detection method.

A production method for a device for detecting an analyte by way of redox cycling is known from Kätelhön et al. (E. Kätelhön, B. Hofmann, S. G. Lemay, M. A. G. Zevenbergen, A. Offenhäusser, and B, Wolfrum, (2010). Nanocavity Redox Cycling Sensors for the Detection of Dopamine Fluctuations in Microfluidic Gradients, Analytical Chemistry, 82, 8502-8509). A first electrode comprising titanium, platinum and chromium deposited on top of one another is disposed on an SiO₂ substrate, a thick sacrificial chromium layer is then applied, and a second electrode comprising chromium, platinum and titanium deposited on top of one another is disposed thereon. The second electrode is opened, whereby the thick sacrificial chromium layer becomes accessible to an etching agent. Said titanium and chromium layers are used for adhesion of the electrode to the substrate or the passivation layer.

After the sacrificial layer has been removed, the design necessary for redox cycling, comprising two electrodes disposed on top of one another in a cavity, is achieved. The electrodes are provided with conductors and contact surfaces, respectively, and are oriented parallel to each other. Up to 29 cavities are thus provided in a biochip and connected against the reference electrode. According to the detection method, the analyte is brought close to the bottom and top electrodes by way of a microfluidic access made of PDMS and detected by the voltage change after the voltage applied against the test electrode. This method can be employed for producing a sensor field comprising several sensors.

The drawback of the sensor system thus produced s that it is limited with respect to the maximum spatial resolution that can be achieved. Electrochemical analyte detection having high spatial resolution is not possible because a large number of measuring devices is required. If data is acquired at the same time, each sensor comprising the two electrodes must be read by a separate measuring device. This increases the costs if the number of pixels is high, and makes the set-up of a measuring apparatus considerably more difficult. While serial data acquisition, in contrast, requires fewer measuring devices, every sensor still must be separately connected to a suitable switch, so that likewise a complex read apparatus is necessary.

Another disadvantage is the packing density of the sensors on the chip, which determines the spatial resolution of the sensor. The devices for redox cycling described above cannot be used to increase the spatial resolution due to the number of conductors. Because every sensor requires two conductors, only low spatial resolution can be achieved with large sensor matrices. As a result, a higher resolution can only be implemented with a significantly reduced number of pixels.

It is known from Lin et al. to dispose an electrode structure comprising two electrodes in a checkerboard pattern. However, attempts to design the devices described in Wolfrum et al. and Kätelhön et al. in a checkerboard-like manner according to the methods described there were not promising.

Thus, it is the object of the invention to provide a method for producing a device, the method allowing a spatially resolved and highly sensitive detection of an analyte.

It is another object of the invention to provide an appropriately designed device, which allows for spatially resolved and highly sensitive detection of an analyte. It is also an object of the invention to provide an advantageous intended use for the device.

The object is achieved by the method according to claim 1, and by the device, and the use of the device, according to the two additional independent claims. Advantageous embodiments will be apparent from the respective claims dependent thereon.

The method for producing a device for detecting an analyte comprises the following steps.
a) A first conductor having an electrode function is disposed on an insulating substrate. The conductor is disposed on a substrate in an appropriate linear manner. The conductor is advantageously made of a material such as gold, platinum and the like. Of course, a plurality of first conductors can be disposed simultaneously. In an advantageous embodiment of the invention, the first conductor, and adhesion layers that may be disposed beneath or above for attaching the first conductor to the substrate and to the passivation layer, are made of materials that are not removed during removal of the sacrificial layer that is later applied. If the sacrificial layer is removed by way of etching, the first conductor is made of a non-etchable material as compared to the sacrificial layer.
b) A first thin passivation layer is disposed on the conductor, which is to say the conductor is rendered passive. The conductor, in effect, no longer has a freely accessible surface, but is completely covered by the passivation layer. The neighboring substrate is preferably passivated thereby at the same time. At the passivation points, advantageously no vertical or horizontal charge transfer takes place during use of the sensor. The passivation advantageously encapsulates the conductor, Because the conductor is made of conductive material and additionally, together with the electrode to be deposited, forms a sensor at this location, if several sensors are formed on the substrate, this step assures that the individual sensors have no contact with each other along a conductor and with neighboring conductors. Because several sensors are formed on each conductor, advantageously the sensors or cavities formed on a single conductor also have no contact whatsoever with each other along this single conductor. The first passivation layer particularly advantageously comprises a material that is not removed during removal of the sacrificial layer that is later applied, if the sacrificial layer is removed by way of etching, the passivation layer is made of a non-etchable material as compared to the sacrificial layer.
c) The passivation layer is then opened in a locally delimited manner, for example in a punctiform manner using an appropriately designed mask, for example by way of etching, so that the conductor is exposed in a locally delimited, for example punctiform, manner. Lithographic methods can be employed for this purpose.
d) Thereafter, a sacrificial layer is disposed on the conductor in the opening. The sacrificial layer is required for forming the nanocavity later between the electrodes. The sacrificial layer can preferably be etched and is made of chromium, for example, or another etchable material.
e) So as to close the opening, an electrode, which is likewise made of gold, for example, is disposed on the sacrificial layer. Together with the section of the first conductor located opposite the sacrificial layer, it is the task of the electrode to form a sensor. Because the first conductor always has an electrode function, since the material is selected from gold, platinum and so forth, it is assured that a sensor can be formed between the electrode and the first conductor.

Steps c) to e) are particularly advantageously carried out in a single lithographic step, whereby the sacrificial layer and the electrode are perfectly aligned on the first conductor at the location of the sensor. As an alternative, method steps e) and f) can be carried out in a single lithographic step using the same mask.
f) A second conductor is then disposed orthogonal to the first conductor on the electrode, wherein the second conductor preferably makes contact with the electrode only at the edge of the electrode. The conductor is preferably deposited by way of lithography so that it has an opening at the site of the electrode, By separating steps e) and f), the electrode and the conductor are deposited separately from one another. This advantageously allows the electrode and the sacrificial layer to be deposited in a single lithographic step using the same mask. In an advantageous embodiment of the invention, the second conductor, and adhesion layers that may be disposed beneath or above for attaching the second conductor to the first passivation layer and the second passivation layer disposed thereafter, are made of materials that are not removed during removal of the sacrificial layer, if the sacrificial layer is removed by way of etching, the second conductor is made of a non-etchable material as compared to the sacrificial layer.
g) A second passivation layer is then disposed on the electrode and on the second conductor, and preferably also on the first passivation layer. The purpose of the second passivation is identical to that of the first passivation. The passivation is carried out in particular over the entire surface of the substrate and of the entire layer structure.
h) The second passivation layer and the electrode are opened in at least one site, whereby the sacrificial layer disposed beneath the electrode is exposed. This provides at least one aperture for the sensor, through which the analyte can reach the sensor electrodes.
i) The sacrificial layer is then removed. As a result, the nanocavity is provided.

Of course, steps a) to i) can be carried out consecutively, multiple times or simultaneously. For example, several first conductors can be simultaneously disposed parallel to each other on the substrate, and several electrodes can be disposed simultaneously. The same applies to the remaining method steps, such as to the arrangement of the second conductors. A checkerboard-like sensor field is thus created, in which every intersecting point of a first with a second conductor forms a sensor having two electrodes for forming a nanocavity.

The first passivation layer on the first conductor is particularly advantageously not removed during removal of the sacrificial layer. As a result, a cavity is formed exclusively in the region of the intersecting point of a first conductor with a second conductor.

A new fabrication process is employed for implementing the sensor according to the invention. The publications by Wolfrum el al. and Kätelhön et al. describe fabrication processes, in which the conductors are attached to the adjoining layers by way of adhesion layers made of chromium. This is necessary so as to remove the adhesion layers together with a sacrificial chromium layer and thus obtain electrodes that are made of the desired material and not covered by an adhesion layer.

It was found within the scope of the invention that the progress of etching this sacrificial layer cannot be controlled with precision. The fabrication in Wolfrum at al. and Kätelhön et al, has the drawback of resulting in nanochannels above or beneath the conductors that extend from one nanocavity to a neighboring nanocavity. In a checkerboard structure, this creates a direct connection between individual neighboring sensors, so that measurements with high spatial resolution are not possible. For this reason, step b) was introduced in claim 1 in the present invention. This passivation allows the nanocavities to be separated from each other.

This advantageously also results in the elimination of chromium adhesion layers as found in the prior art according to Wolfrum et al. and Kätelhön et al., so that all the conductors can be attached to the substrate and to the passivation layer by way of titanium adhesion layers, for example. During the subsequent removal of the sacrificial layer, these are also left untouched, as is the passivation layer.

This means that an electrode pair (sensor), which is used for redox reactions on the analyte, is formed between the (top) electrode deposited at the intersecting point and the section of the first conductor at this point. Because the nanocavity having a gap S can be accessed from the outside only via the aperture, en analyte can penetrate from above (see figure) and be consecutively reduced and oxidized by way of diffusion to the electrodes, depending on to which of the two electrodes a positive voltage or a negative voltage is applied.

The method is advantageously characterized by the selection of a sacrificial layer that can be etched. Etching can be carried out using a wet-chemical or dry-chemical method.

Steps c) to e) are particularly advantageously carried out in a single lithographic step using only one mask. This assures an exact alignment of the electrode on the sacrificial layer above the first conductor. It is thus ensured that the electrode and the opposing section of the first conductor are exactly aligned with one another and thus form a sensor for detecting the analyte.

As an alternative, steps e) and f) can also be carried out in a single lithographic step using the same mask.

The second passivation layer and the electrode are particularly advantageously opened by holes in a hexagonal arrangement. For this purpose, the person skilled in the art will weigh between preserving the sensor surface on the one hand, because material of the top electrode is removed when forming the holes, and accessibility of the nanocavity for the analyte on the other hand. Several small holes having a diameter on nanometer scales (for example up to 250 nm) sure that the analyte to be detected can diffuse well via the holes into the gap S between the electrodes and, at the same time, detection of the consecutive redox reactions of the analyte is assured, while preserving the comparatively large electrode surface (for example up to 100 μm in diameter). Several holes particularly advantageously reduce the response time of the sensor.

Several holes advantageously also improve the response behavior of the sensor to fast changes in the analyte concentration close to a measuring intersecting point, as would be expected during the release of neurotransmitters by neurons localized thereby, for example. Because, in this case, the sensor is exposed to the analyte only for an extremely short time and only analyte molecules that are in fact located within the nanocavity between the electrodes can be detected, the magnitude of the sensor response here notably depends on the gap length of the opening to the nanocavity. This means that highly localized lengthening of the gap opening by many small openings is generally advantageous for detecting short, positive concentration pulses.

The device for detecting analytes is characterized in that a self-contained nanocavity for receiving the analyte between the conductors is disposed at the intersecting point between at least two conductors that are orthogonal to one another, wherein above and below a gap S, for the purpose of forming the nanocavity, two mutually opposing regions of the first and second conductors form electrodes for a sensor, which allows an analyte to be detected by consecutive oxidation and reduction of the analyte on the electrode. The electrode is made of the same material as the second conductor and is disposed in the same plane. The nanocavity is self-contained because it has no inward or outward access whatsoever, apart from the openings formed in step h). The nanocavities in particular have no lateral connection to other nanocavities. A connection between the nanocavities can only be made via the sensor inputs (apertures). The conductors are advantageously passivated, with the exception of the intersecting points.

In one embodiment of the invention, a plurality of intersecting points of a plurality of conductors disposed orthogonal to each other are disposed in the device. A nanocavity is formed between two orthogonal conductors at each intersecting point. No connection exists between neighboring nanocavities, in particular there is no connection whatsoever by way of diffusion of the analyte, except via the sensor input (aperture) itself. This advantageously results in high spatial resolution of the sensor field because each nanocavity and the sections of the conductors surrounding it form a self-contain sensor system for detection. The sensitivity of each individual sensor, in turn, is assured by redox cycling.

Particularly advantageously, approximately 6 sensors can thus be disposed on a substrate surface of 100 μm². In comparison with the prior art according to Lin et al. it may be noted that there each sensor takes up an area of approximately 60000 μm².

The measurement is carried out in each case at the intersecting points of the conductor, utilizing the redox cycling effect. During the measurement process, the signals can optionally be read serially or line by line at the individual intersecting points.

In the case of serial data collection, oxidizing and reducing potentials are applied to two conductors, respectively, that are orthogonal to one another, while all other electrodes ideally are not connected or a potential is applied to them, at which no redox cycling can take place between the electrodes. As a result, redox cycling takes place at exactly one intersecting point, wherein the corresponding redox cycling currents can be read at one of the two active electrodes. During the measurement, in addition to the redox cycling currents, Faraday currents occur at the nanocavities along the active electrodes. But because of the massive amplification of the electrochemical signal due to the redox cycling effect, these currents are negligible with respect to the redox cycling signal.

In the case of simultaneous line-by-line data collection, an oxidizing or reducing potential is applied in each case to several parallel electrodes (A), while a reducing or oxidizing potential is set at an electrode (B) that is orthogonal thereto. All other electrodes are either not connected or a potential is applied thereto, at which no redox cycling occurs. Redox cycling thus takes place simultaneously at all intersecting points of (A) with (B). The redox cycling currents can then be measured simultaneously at the electrodes (A) for the respective intersecting point, while the sum of redox currents of (A) is present at electrode (B).

The advantageous use of the device lies in the detection of neurotransmitters as analytes.

Because the device, as described, is passivated, it is also biocompatible, Neurons can be cultivated directly on the device by applying proteins to the surface of the device. The released neurotransmitters are detected in real time.

The invention will be described in greater detail hereafter based on an exemplary embodiment, without thereby limiting the invention.

In the drawing:

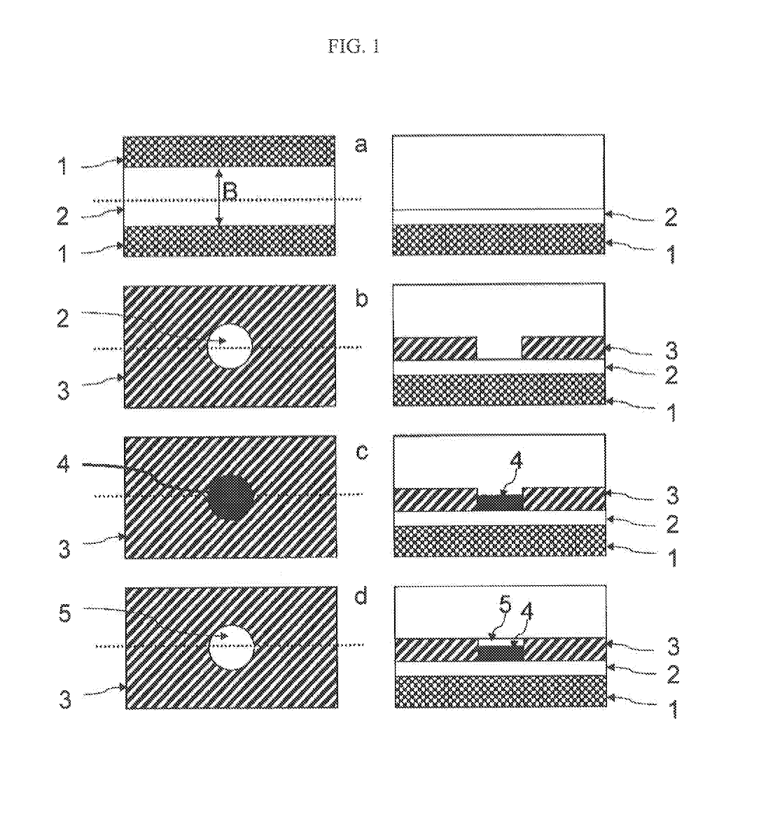

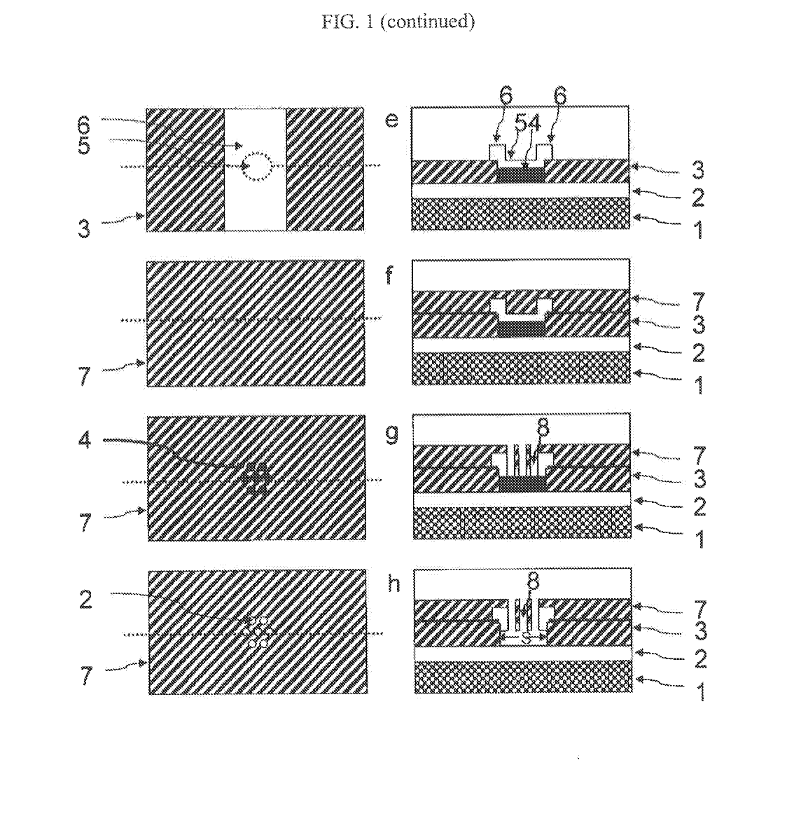

FIG. 1: shows a production method according to the invention.

### BRIEF DESCRIPTION

After the first gold conductor 2 has been deposited on the substrate 1, a thin SiO₂ passivation layer 3 is applied (FIG. 1e). This is opened by way of reactive ion etching (FIG. 1b) at the later intersecting point of the first 2 with the second 6 conductor. In the same structuring step, a sacrificial chromium layer 4 and a thin layer made of the electrode material, this being gold 5, are deposited into the opening. The top conductor 6 and a further passivation layer 7 are then applied. The further, second passivation layer and the electrode are opened at the intersecting points with the bottom conductors by way of reactive on etching (FIG. 1g) so that the sacrificial chromium layer 4 can be removed by way of a wet-chemical process (FIG. 1h), Because the conductors were attached by way of titanium adhesion layers (not shown), this etching step does not result in any nanochannels whatsoever between the different intersecting points.

These steps can, of course, be carried out consecutively multiple times, or simultaneously, so as to arrive at a checkerboard-like sensor field, which comprises as r a sensors as there are intersecting points of first with second conductors.

### DETAILED DESCRIPTION

The fabrication process for creating a single intersecting point is shown by way of example in FIG. 1. The respective top view is shown on the left, and the related cross-sectional view on the right of the figure. The dotted line indicates the location of the section.

The bottom conductor 2 (width B: 1 to 100 μm, in the present example 5 μm, thickness: 30 nm to 1 μm, in the present example 150 μm, for example) is deposited by way of optical lithography and lift-off. For this purpose, first an adhesion layer made of titanium (not shown) having a width of 5 μm and a thickness of 7 nm is deposited on the oxidized wafer 1. The gold layer 2 is disposed thereon (FIG. 1a).

FIG. 1b shows the deposition of a thin passivation layer 3 by way of PECVD. The thickness can be 50 nm to 2 μm; in the present exemplary embodiment, 400 nm was used.

FIG. 1b also shows the opening of the passivation layer 3 at a future intersecting point. The diameter of the opening can be 0.8 to 80 μm and can be made by way of reactive ion etching. In the present example, a diameter of 4 μm was used.

Thereafter, a sacrificial chromium layer 4 is directly deposited in the opening (FIG. 1c). The thickness can be 10 nm to 1 μm; in the present example it is 50 nm. The layer 4 has the same diameter as the opening and the process used is, once again, optical lithography and lift-off.

Thereafter, a thin top electrode 5 is directly deposited onto the sacrificial layer made of chromium 4 by way of optical lithography and lift-off. The thickness of the electrode is between 10 and 100 nm; in the present example it is 30 nm. It has the same diameter as the sacrificial layer 4.

It is useful to carry out the steps of FIGS. 1b (forming the opening), 1c (arranging the sacrificial layer) and 1d (arranging the top electrode 5) in one lithographic step and using only one lift-off. While this makes the lift-off slightly more difficult, it assures absolutely exact alignment of the sacrificial layer 4 and electrode 5 above the conductor 2 with respect to each other.

In the next step, the top conductor 6 having a width of 1 to 100 μm, for example, in the present example 5 μm, and a thickness of 30 nm to 1 μm, in the present example 150 nm, is deposited by way of optical lithography and lift-off. The top conductor has a hole at the site where the top thin electrode 5 is seated, which is to say it is not deposited at this site. An overlap of 1 to 5 μm must exist with the edge of the top electrode 5 so as to allow contact therewith (FIG. 1e). As with the bottom first conductor 2, a titanium layer is deposited, as shown there, onto the top second conductor 6. This allows the gold layer 6 to adhere to the subsequent passivation layer 7.

The passivation layer 7 (FIG. 1f) is produced by way of PECVD. The thickness can range between 50 nm and 2 μm; in the present exemplary embodiment, 800 nm SiO₂ was deposited.

Thereafter, the passivation layer 7 and the gold electrode 5 are opened after optical lithography by way of reactive ion etching, for example with seven openings 8 in the present example, in a hexagonal sphere packing, with an opening diameter of 10 nm to 20 μm. In the exemplary embodiment, the holes were created by way of electron beam lithography. The holes should be adapted to the size of the sensor 2, 5 at the intersecting point. The resulting aperture allows the analyte to penetrate to the electrodes of a sensor in this way, however advantageously not laterally via inner channels from one sensor to another sensor.

Other designs are likewise possible for the openings 8. The design of the openings 8 influences the response times and efficiency of the sensor. A large number of closely spaced small holes 8 in relation to the top electrode 5 improve the response time of the sensor due to fast diffusion in contrast with a single small hole 8. This allows for faster measurements. In return, the efficiency of the redox cycling is slightly reduced because the sensor surface is decreased by the elimination of material of the top electrode 5. A large individual hole 8 likewise improves the response time, but lowers the amplification of the redox cycling due to the smaller effective electrode surface 5, 2 at the intersecting point,

In the last step, wet-chemical etching of the sacrificial chromium layer 4 is carried out,

The finished sensor is shown in FIG. 1h. A gap S indicates the width of the nanocavity between the opened top electrode 5 and the opposing section of the bottom conductor 2. Both together provide the sensor at the intersecting point of the conductors 2 and 6. If the gold conductors had adhered by way of chromium (see Wolfrum et al. and Kätelhön et al.), additional channels would be formed in the interior of the layer structure during etching, and the nanocavity would be open at these sites. This would result in crosstalk between neighboring nanocavities due to diffusion of the analyte. The spatial resolution would then be impaired.

The substrate 1 used is a 100 mm Si wafer having a 1 μm thick SiO₂ passivation layer, The thickness plays a subordinate role. It should be selected so that sufficient insulation is provided. The conductors 2, 6 are applied by way of electron beam evaporation and structured by way of lift-off.

In doing so, the following protocol is followed: The photoresist LOR3b™ is spun on at 3000 rpm and cured on a heating plate for 5 minutes at 180° C. Thereafter, the photoresist nLOF 2020™ is spun on at 3000 rpm and cured on a heating plate for 90 seconds at 115° C. Exposure is carried out by way of a mask in the Mask Aligner. The photoresists are developed in MIF326™ for 45 seconds. The lift-off of the metal layer is carried out in acetone.

The protocol is carried out several times, wherein the following layers are deposited. The first bottom conductors comprise 150 nm gold on 7 nm titanium as the adhesion layer. The top second conductors comprise 7 nm titanium, 150 nm gold and another 7 nm titanium.

Passivation layers made of SiO₂ and/or Si₃N₄ are deposited using PECVD and have thicknesses between 50 and 800 nm. This passivation layer is then structured using the photoresist AZ 5214-E™ and reactive ion etching based on the following protocol. Thereafter, the photoresist AZ 5214-E™ is spun on at 4000 rpm and cured on a heating plate for 5 minutes at 90° C. Exposure is carried out. Thereafter, the photoresist is developed in MIF326™ for 60 seconds and reactive on etching is carried out using 200 W, 20 ml/s CHF₃, 20 ml/s CF₄ and 1 mils 0₂.

In the steps of FIGS. 1b to 1d, this photoresist is used both for opening the passivation layer and for the lift-off of the sacrificial chromium layer 4 and upper electrode 5 with acetone. These have a respective thickness of 50 nm (chromium) and 20 nm (gold).

The sacrificial chromium layer 4 is removed by way of a wet-chemical process using a chrome etch™ solution. For this purpose, the sensor field is covered with the etching solution for approximately 30 minutes and then rinsed with water.

1. A method for producing a device for detecting an analyte, comprising the following steps:
(a) disposing a first conductor having an electrode function on an insulating substrate;
(b) disposing a first passivation layer on the conductor;
(c) opening the passivation layer in a locally delimited manner, so that the conductor is exposed in a locally delimited manner;
(d) disposing a sacrificial layer on the conductor in the opening;
(e) disposing an electrode on the sacrificial layer;
(f) disposing a second conductor orthogonal to the first conductor, wherein the second conductor makes contact with the electrode;
(g) disposing a second passivation layer on the electrode and on the second conductor;
(h) opening the second passivation layer and the electrode so that the sacrificial layer is exposed; and
(i) removing the sacrificial layer.

2. The method according to claim 1, wherein the selection of a sacrificial layer that can be etched.

3. The method according to a claim 1, wherein steps c), d) and e) are carried out in a single lithographic step using the same mask.

4. The method according to claim 1, wherein steps e) and f) can be carried out in a single lithographic step using the same mask.

5. The method according to claim 1 wherein the second passivation layer and the electrode are opened with holes in a hexagonal arrangement.

6. The method according to claim 1, wherein in step i), only the sacrificial layer is removed.

7. The method according to claim 1, Wherein in step h) the substrate is also passivated,

8. method according to claim 1, wherein in step g), the second passivation layer is also disposed on the first passivation layer.

9. A device for detecting an analyte, in which a nanocavity for receiving the analyte between the conductors is disposed at the an intersecting point between at least two conductors that are orthogonal to one another, and above and below a gap, for the purpose of forming the nanocavity, two mutually opposing regions of the first conductor and on the second conductor form electrodes so as to form a sensor, which allows an analyte to be detected by consecutive oxidation and reduction of the analyte on the electrodes, wherein the first conductor is separated from the second conductor by a first passivation layer,

10. The device according to claim 9, comprising a plurality of intersecting points, formed by a plurality of conductors that are disposed orthogonal to each other, wherein a nanocavity is formed between the electrodes and the conductor at every intersecting point and no connection exists between neighboring nanocavities.

11. The device according to claim 9, wherein up to 6 sensors are disposed on an area of 100 μm².

12. Use of the device according to claim 9, comprising the detection of neurotransmitters as the analyte.
